(19) United States
(12) Patent Application Publication
(10) Pub. No.: US 2024/0030583 A1
(43) Pub. Date: Jan. 25, 2024

(54) ELECTROCHEMICAL METHOD FOR FABRICATION OF HIGH-PURITY, HIGH-CONDUCTIVITY CORRUGATED WAVEGUIDES

(71) Applicant: Faraday Technology, Inc., Englewood, OH (US)

(72) Inventors: Danny Xin Liu, Tipp City, OH (US); Holly Garich, Fairborn, OH (US); Timothy D. Hall, Englewood, OH (US); Earl Jennings Taylor, Bonita Springs, FL (US)

(21) Appl. No.: 18/353,265

(22) Filed: Jul. 17, 2023

Related U.S. Application Data
(60) Provisional application No. 63/391,363, filed on Jul. 22, 2022.

(51) Int. Cl. H01P 11/00; C25D 1/02; C25D 21/12

(52) U.S. Cl. CPC H01P 11/002; C25D 1/02; C25D 21/12

(57) ABSTRACT

A method of manufacturing a corrugated copper microwave waveguide comprising placing a mandrel with external corrugations in an electrolyte bath substantially devoid of brighteners, accelerators, or levelers and including copper ions, sulfuric acid, chloride, and polyethylene glycol. The mandrel is placed proximate a copper anode in the bath. One or more waveforms are applied to the mandrel and anode to control electrodeposition distribution of copper to the mandrel rather than controlling the electrolyte bath chemistry. The mandrel and the resulting electroformed waveguide are removed from the electrolyte bath and the mandrel is excised (e.g., dissolved) resulting in a microwave waveguide with internal corrugations. Substantially devoid of additives (brighteners, accelerators, and/or levelers) generally means not having to repeatedly meter in additives during the electroforming process.

### RELATED APPLICATIONS

This application claims benefit of and priority to U.S. Provisional Application Ser. No. 63/391,363 filed Jul. 22, 2022, under 35 U.S.C. §§ 119, 120, 363, 365, and 37 C.F.R. § 1.55 and § 1.78, which is incorporated herein by this reference.

### GOVERNMENT RIGHTS

This invention was made with U.S. Government support under Contract No. DE-SC0020782 awarded by the Department of Energy. The Government has certain rights in the subject invention.

### FIELD OF THE INVENTION

This invention relates, in one preferred embodiment, to the electroforming of copper onto aluminum mandrels, followed by dissolution of the mandrels, to form waveguides for high frequency microwave applications.

### BACKGROUND OF THE INVENTION

High gradient acceleration is a key requirement in future large-scale linear colliders. Intense effort has been devoted to X-band (˜12 GHz) normal conducting structures, largely driven by the proposed TeV-colliders projects (Next Linear Collider (NLC), Compact Linear Collider (CLIC) and the like). Several prototype structures capable of operation at 100 MV/m have been successfully developed by an international collaboration led by the European Council for Nuclear Research (CERN, Switzerland), Stanford Linear Accelerator Center (SLAC, USA) and the High Energy Accelerator Research Organization (KEK, Japan). Studies at higher frequencies (millimeter wave to THz) are emerging to further improve the structure performance and reduce cost. The major justification of using high frequency structures can be listed as follows.

In two-beam acceleration scheme, the base-line design of CLIC, the drive beam is decelerated in a decelerating structure (a.k.a. power extraction and transfer structure, or PETS for short) to generated rf power for the accelerator. The generated rf power follows P=cβₐω(r/Q)Q_{b}²F²/4/(1−βₐ)², where c is the speed of light, βₐ is PETS group velocity, ω is operation frequency, r/Q is PETS shunt impedance that scales linearly with ω, Q_{b} is drive beam charge, and F is the form factor. With the same drive beam charge and form factor, the generated rf power scales as P≢f².

In two-beam acceleration and klystron-driven schemes, the build-up electric field follows E=\sqrt{(ω/c/β_{g})(r/Q)P}, which linearly scales with operation frequency.

Although there is still no conclusive dependence of the maximum achievable gradient on the operation frequency, higher gradients have been obtained using millimeter wave and THz structures: 300 MV/m in a 110 GHz structure and >10 GV/m in a 560 GHz structure.

The structure could be more compact as its transverse size scales as f⁻¹. This is attractive to high energy machines for scientific research, and low energy accelerators for industrial/medical/security applications.

Traditional fabrication methodologies for manufacturing waveguides for high frequency microwave applications lack the precision and practicality for producing small features required of higher frequency ranges (>30 to 300 GHz). Typical metal fabrication approaches are broadly classified as machining or electroforming. Machining strategies often leverage direct contact abrasion, heat, or chemical etching to yield the desired pattern or features and include laser machining, hydraulic cutting, single-point diamond turning, diamond grinding, photochemical machining, or electrodischarge machining. These methods are appropriate for producing relatively large (>1 mm) features but challenges arise for small (<1 mm), well-defined features, resulting from the inherent nature of these machining methods that can impart/create burrs, surface roughening through machining marks/craters, localized heat damage, and/or tool grain inclusion on the workpiece. Due to mechanical tool wear over time, traditional machining methods cannot yield reliable/reproducible features. For sub-millimeter features required for higher frequency applications, these imperfections become a field emitter under high power operation, experience ohmic losses, and detrimentally impact signal transmission. Surface defects could lead to radio frequency breakdowns that limit the achievable gradient. Although advancements in micro-machining technologies including optical lithography, wet chemical etching, ion beam etching, and lithography-electroforming-moulding (LIGA) show promise for etching features on the <1 mm scale, improvements in anisotropic etching, etch rate, masking are required for practical implementation.

Copper waveguides with corrugations are of particular interest for accelerator applications due to their high-vacuum compatibility, high electrical conductivity, and commercial availability at high purity levels. These waveguide applications necessitate oxygen-free copper (99.95% copper and ˜0.001% oxygen content). Since the waveguide would be subjected to vacuum environments, the high purity requirement limits outgassing as well as signal attenuation due to impurities. However, oxygen-free copper is more difficult to machine, with a Machinability Index Rating (MIR) of 20 when compared to the lower purity, oxygen-containing grades (see Table I).

TABLE I
Machinability Index Rating (MIR)

| MATERIAL | MACHINABILITY INDEX |
|---|---|
| BRASS | 100 |
| C-20 Steel | 65 |
| C-45 Steel | 60 |
| Stainless Steel | 25 |
| Copper (>88% Cu) | 70 |
| Copper (>99.95% Cu) | 20 |
| Aluminum Alloys | 300-1500 |
| Magnesium Alloys | 600-2000 |

MIR provides a reasonable, relative, approximate comparison by assigning a numerical value for the ease at which a material can be machined. This value is based on allowable machining speed, tool wear, finish, accuracy, and power requirements. The MIR of 20 for oxygen-free copper is referenced against a material that is very easy to machine, free-cutting brass (MRI=100). Thus, machining difficulty stems from the high ductility, high cold-workability, high tool wear, and poor chip formation of oxygen-free copper.

Electroforming processes are known in the printed circuit industry but, to date, waveguides are still manufactured using machining processes.

### BRIEF SUMMARY OF THE INVENTION

Featured is an electroforming process for precision fabrication of corrugated copper waveguides.

The problem(s) of precision fabrication of high conductivity (>800 Residual-resistance ratio (RRR)) oxygen-free copper waveguides is solved by using a pulse/pulse reverse process in conjunction with electroforming copper onto an aluminum mandrel, followed by dissolution of the mandrel.

The problem of fabricating high-purity (oxygen-free grade) copper waveguides for high-frequency applications in the millimeter wave regime, where these higher frequencies leverage reduced wavelengths and enable increased signal throughput, and necessitate structural features with sub-millimeter dimensionally accuracies and submicron surface finishes, is solved by a scalable electroforming approach where modulating the electric field with pulse-based waveforms during electroforming enable the ability to accurately confer structural features exhibiting sub-millimeter dimensionally accuracies while ensuring high-purity by avoiding additive-induced contamination that would have otherwise been prevalent in conventional direct-current (DC) and/or other additive-containing electroforming approaches, onto an easily machinable mandrel, that may be constructed from aluminum or its alloys, that exhibit corresponding and complementary structural features, and the mandrel can be removed to yield the copper waveguide.

The feasibility of the invention has been demonstrated via an electroforming process used to fabricate 26 GHz waveguide structures with tailored corrugation features. Optimization of pulse waveform parameters along with custom-built electroforming apparatus enabled successful copper filling of the corrugation valleys on the mandrel. In one embodiment the copper waveguides were prepared by pulse reverse current electroforming and were cross-sectioned and verified to have solid, void-free corrugation structures. In another embodiment the copper wave guides were prepared by pulse current electroforming and were cross-sectioned and verified to have cooling channels within the corrugation structures. The resulting copper waveguides were characterized by optical microscopy and non-contact profilometry to validate shape fidelity and dimensional accuracy. Optimization for operation at higher frequencies (e.g., 30-300 GHz), include design, fabrication, and beam test of ˜182 GHz waveguide structures.

Polyethylene glycol and chloride (PEG/Cl) additions provide recrystallization of the deposit; accelerators, brighteners and levelers are not required, as control of the copper distribution is achieved using the waveform, rather than bath chemistry.

A conductivity value of approximately 850 RRR is possible resulting in improved waveguide performance. In addition, bath maintenance/monitoring (e.g., additive replenishment) is minimized.

The result is a more robust, higher conductivity waveguide with optimum mechanical properties. Tensile strengths of 174 MPa and yield stress values of 831 MPa are possible.

Featured is a method of manufacturing a corrugated copper microwave waveguide comprising placing a mandrel with external corrugations in an electrolyte bath substantially devoid of brighteners, accelerators, or levelers and including copper ions, sulfuric acid, chloride, and polyethylene glycol. The mandrel is placed proximate a copper anode in the bath. One or more waveforms are applied to the mandrel and anode to control electrodeposition distribution of copper to the mandrel rather than controlling the electrolyte bath chemistry. The mandrel and the resulting electroformed waveguide are removed from the electrolyte bath and the mandrel is excised (e.g., dissolved) resulting in a microwave waveguide with internal corrugations. Substantially devoid of additives (brighteners, accelerators, and/or levelers) generally means not having to repeatedly meter in additives during the electroforming process.

An exemplary waveform is a cathodic current followed by an anodic current repeated for approximately 24-48 hours. Waveguide thickening may then follow in the electrolyte bath using the same procedure for between 24-48 hours.

In one example, a mandrel with external corrugations is placed in an electrolyte bath substantially devoid of brighteners, accelerators or levelers and including copper ions, sulfuric acid, chloride, and polyethylene glycol. There is a copper anode in the bath proximate the mandrel. One or more waveforms are applied to the mandrel and anode to control electrodeposition distribution of copper to the mandrel rather than controlling the electrolyte bath chemistry. The mandrel and the resulting electroformed copper waveguide are removed from the electrolyte bath and the mandrel is excised resulting in a microwave waveguide with internal corrugations.

In one example, the waveguide internal corrugations have a sub-millimeter width and a sub-millimeter distance between adjacent corrugations.

Preferably, the copper anode is substantially oxygen free. The mandrel can be made of aluminum or an aluminum alloy.

The waveforms can include a cathodic current followed by an anodic current repeated for a predetermined time (e.g., between 24 and 48 hours). The cathodic current can range from 10 to 50 mA/cm² with cathodic current on-times that can range from 0.1 to 100 ms and the anodic current can range from 5 to 200 mA/cm² and the anodic current on-times can range from 0.1 to 10 ms. The method may further include a waveguide thickening method such as applying a cathodic current waveform followed by an anodic current waveform for a predetermined time (e.g., between 24-48 hours).

The waveguide may have an inner diameter of approximately 7 mm and a corrugation period of 1.38 mm and corrugations that are rectangular in cross section.

Preferably, applying the one or more waveforms to the mandrel and anode controls electrodeposition of copper to the mandrel to conformally deposit the copper to the mandrel without dog bone features. In one example, applying the one or more waveforms to the mandrel and anode controls electrodeposition of the copper to the mandrel and results in keyholes through the waveguide internal corrugations.

Excising the mandrel may include dissolving the mandrel using a hot concentrated caustic solution. The copper anode may have an RRR value of approximately 100 and the copper waveguide may have an RRR value of between 490 and 860.

Also featured is a method of manufacturing a corrugated copper microwave waveguide, the method comprising placing a mandrel with external corrugations in an electrolyte bath substantially devoid of chemical agents which decrease copper electrode deposit purity and/or resistivity and/or which result in outgassing; locating a copper anode in the bath proximate the mandrel; applying repeated cathodic current and anodic current waveforms to the mandrel and anode to electrodeposit a conformal copper electroform to the mandrel; removing the mandrel and the resulting conformal electroform from the electrolyte bath; and dissolving the mandrel resulting in a microwave waveguide with internal corrugations.

The bath is preferably devoid of brighteners, accelerators, and levelers but does usually include copper ions. The bath may include an ionic conductivity medium and one or more recrystallization mediums such as sulfuric acid, chloride, and polyethylene glycol.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 illustrates a section of a corrugated waveguide from the prior art machined using a tap illustrating chips in the corrugated waveguide features.

FIG. 2 illustrates one embodiment of the instant invention for fabricating a corrugated waveguide by electroforming with either cooling channels in the corrugated features or solid corrugated features.

FIG. 3 illustrates one embodiment of an electroforming cell and system from the instant invention.

FIG. 4 illustrates a section of a corrugated feature plated using direct current in conjunction with an electrolyte with brighteners, accelerators and levelers and other additives from the prior art with said additives incorporated within the corrugated waveguide.

FIG. 5 illustrates a section of a corrugated feature plated using direct current in conjunction with an electrolyte devoid of brighteners and accelerators and other additives from the prior art with irregular voids within the corrugated waveguide.

FIG. 6 illustrates a generalized pulse waveform from the instant invention.

FIG. 7 illustrates one embodiment of the instant invention of a section of a corrugated waveguide using pulse reverse current electroforming resulting in solid corrugated waveguide features.

FIG. 8 illustrates one embodiment of the instant invention of a section of a corrugated waveguide using pulse current electroforming resulting in cooling channels within the corrugated waveguide features.

FIG. 9 illustrates a corrugated waveguide electroformed on a mandrel, (a) prior to mandrel removal and (b) after mandrel removal.

FIG. 10 depicts a cross-section topography of a corrugated waveguide after removal of the mandrel.

FIG. 11 depicts a view of a corrugated waveguide after removal of the mandrel.

FIG. 12 presents the desired dimensions of one embodiment of a corrugated waveguide.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

Electroforming involves electrodeposition of the desired species onto a machined, shaped, or patterned metal mandrel, usually stainless steel or aluminum. Subsequent mandrel separation is achieved through mechanical force, thermal treatment, or chemical dissolution, yielding the electrodeposited material (electroform). Advantages of electroforming include high purity of deposited materials, fabrication of a single/continuous-piece (no brazing or welding), and ability to produce electroforms with complex shapes and features. The electroform shape and features are imparted as the “negative image” of the mandrel, which can be reproduced with a one-micron tolerance. Conventionally, electroforming employs a constant current (or voltage).

Thus, features are ultimately constrained by the mandrel properties and determined by the accuracy of the machined feature dimensions on the mandrel. The mandrel is typically installed on a lathe, the most economical and accurate method of machining axis-symmetric features, such as corrugations, and achieve surface finishes (Ra) of 0.05 μm or better.

One challenge of electrodeposition onto mandrels containing high aspect ratio or complex features is inclusion of voids within the features. The void formation stems from the uneven distribution of the local current density throughout the depth of the mandrel features. The non-uniform current distribution results in select regions receiving a higher rate of copper electrodeposition where regions of high current density (near peaks/edges) experience copper electroreduction at a proportionally higher rate than the trenches/valleys. The deposit is classified as exhibiting a “dog-bone” feature due to the obvious resemblance. Eventually, the accumulation of copper electrodeposit covers and seals the surface, resulting in voids and other inclusions trapped throughout the final electroform. Regarding waveguides operating at higher than conventional frequency ranges, these non-uniformities may detrimentally impact the waveguide cooling, outgassing, and transmission properties.

To combat challenges involved with void formation, the semiconductor industry employs chemical additives within copper plating baths. Advancements in copper electrodeposition were driven by the silicon chip industry's transition from vacuum-deposited aluminum to copper plated interconnects. Much development focused on electrodeposition processes that fill the inlaid trench features to permit void-free interconnect wirings. By building upon previous copper-sulfate-based plating baths and processes designed for through-hole plating of printed circuit boards, similar formulations were employed to fill micron and submicron inlaid trench features. To mitigate the void formation/inclusion phenomena, chemical additives such as “levelers” or “accelerators/brighteners” were added to the plating bath to promote filling of the trench features. Levelers are typically aromatic nitrogen-containing molecules (e.g., benzotriazole) that promote mirror-like finishes through differential inhibition of the copper plating kinetics by selective surface diffusion-adsorption, promoting filling of the inlaid trench features. An alternative trench filling strategy involves using sulfur-based organics [bis(sodiumsulfopropyl) disulfide (SPS)], which are introduced within the inlaid trench and functions as a catalyst to induce preferential filling of these features.

Commercial additive packages include proprietary formulations with agents such as levelers and accelerators in varying concentrations. Due to numerous chemical components and their complex interactions under dynamic conditions, underlying mechanisms remain poorly understood, but these additives are often incorporated into the copper during plating, adversely impacting the resulting copper electrodeposit purity. SPS has been reported to irreversibly chemisorb onto copper. The incorporation of SPS as well as elemental constituents of C, O, S, Cl are reported to be dependent on current density and estimated to range from 1-100 ppm. Time-of-Flight SIMS supports incorporation of SPS and impurities. Incorporation of levelers has been studied through XPS and found that impurities and their concentration affected copper film resistivity. Although these additives may result in plating with acceptable copper purity for the silicon chip interconnects, additive inclusion as impurities could have a detrimental impact for waveguides operating at higher than conventional frequency ranges through outgassing and signal attenuation. Use of copper electrodeposition baths that do not require these levelers and accelerators has demonstrated the ability to deposit copper into small features of printed circuit boards and semiconductor wafers, down to 500 nm.

One electroforming process utilizes a high frequency pulsed waveform tuned to a) overcome ohmic resistances, and b) control current distribution, and therefore copper distribution on the surface, in a simple, robust low-additive electrolyte. See U.S. Pat. Nos. 6,203,684; 6,210,555; 6,303,014; 6,309,528; 6,319,384; 6,524,461; 6,551,485; 6,652,727; 6,750,144; 6,827,833; 6,863,793; 6,878,259; 8,603,315; and 10,100,423 incorporated herein by this reference.

This approach can be tuned to achieve void-free copper electrodeposition for trench filling with minimal surface coverage, or conformal deposition, thus circumventing the “dog-bone” effect (disproportional accumulation of deposit at the edges/corners resulting in features resembling the end of a dog-bone). This method has been demonstrated for printed circuit board and semiconductor features as small as 0.5 μm, and herein is adapted to the fabrication of complex waveguide structures, enabling a scalable manufacturing path. The polyethylene glycol and hydrochloric acid (PEG/Cl) additions provide recrystallization of the deposit; accelerators, brighteners and levelers are not required, as control of the copper grain size and distribution is achieved via the waveform, rather than bath chemistry. The copper sulfate/sulfuric acid/PEG/Cl—plating chemistry was chosen for simplicity and ease of control. The electrodeposition process addresses deposition characteristics via current distribution control. Other copper plating chemistries, if proven to have advantages, could also be utilized.

Electroforming enables the desired low-additive, copper deposition onto small corrugated features to become a fabrication reality. The traditional electroforming process begins with a metal mandrel that serves as the foundation for electrodeposition. The mandrel (cathode) along with suitable anode(s) are submerged in an electrolyte containing the target metal ion. Upon application of constant current or voltage, ions are driven to electrochemically reduce onto the mandrel—resulting in the electroform. See, for example, U.S. Pat. Nos. 3,772,619 and 4,906,951 incorporated herein by this reference. See also Siy et al., Fabrication and Testing of Corrugated Waveguides for a Collinear Wakefield Accelerator, Physical Review Accelerators and Beams 25, 021302 (2022). One difference between traditional electroforming and the new approach resides in how the current or voltage is applied. The disclosed electroforming process involves the application of pulses throughout electrodeposition, enabling simple, low-additive deposition baths, that ultimately results in enhanced control over electroform properties (morphologies, grain sizes) and enables fabrication of complex waveguide geometries and varying corrugation features for low-loss, high frequency structures.

Electroforming is production or reproduction of articles by electrodeposition upon a mandrel or mold that is subsequently separated from the deposit. Electrodeposition is an electrochemical process by which metal is deposited on a substrate by passing an electrical current through the bath. The applied voltage causes positive ions to migrate towards the negatively-charged cathode. The metal ion adsorbs onto the cathode surface, and a discrete number of electrons will produce a metal atom, which migrates to a position within the growing metal lattice. Provided that the surface is properly cleaned and activated, the electroplated layer is adherent and bonded on an atom-to-atom basis. During DC electrodeposition, the applied voltage or current is held at constant value for the duration. During electrodeposition as described herein, the voltage or current is pulsed, i.e., turned on and off, and the polarity of the electrodes may be switched numerous times during the process.

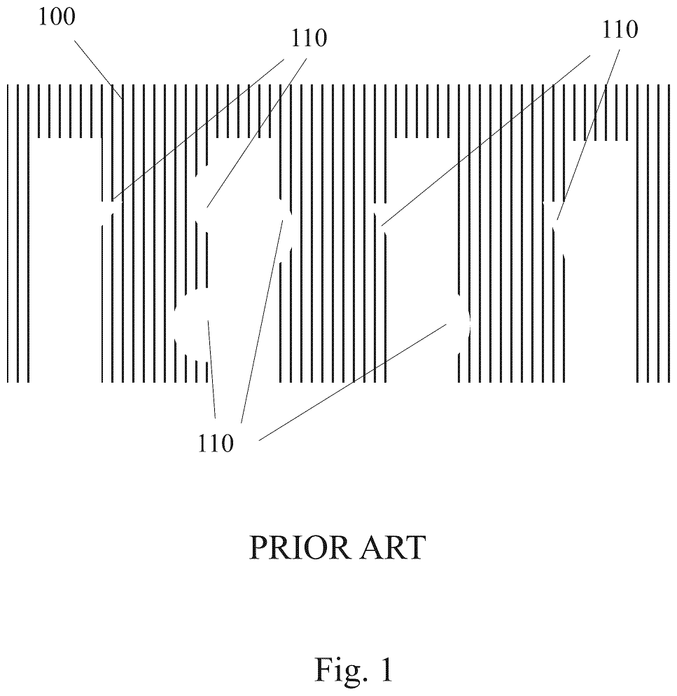

In FIG. 1, the internal waveguide corrugations or teeth 100 are machined using a tap resulting in chips such as chip 110 due at least in part to the low MIR value of the oxygen free copper used for the waveguide.

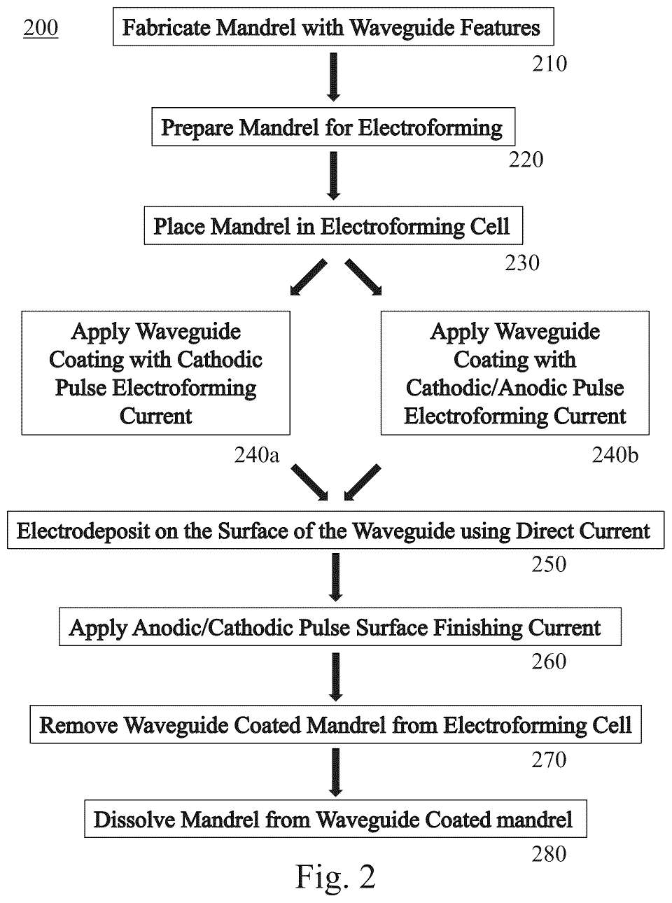

In FIG. 2, an example of an electroforming process 200 for fabricating a corrugated waveguide comprising the following steps; fabricating a mandrel 210 with waveguide features, step 210. The waveguide features can be mechanically machined into a mandrel made from aluminum and aluminum alloys due to their MIR of 300 to 1500. Next the mandrel is prepared for electroforming, step 220, by degreasing and cleaning the mandrel surfaces. The mandrel is then placed, step 230, and suitably positioned in an electroforming cell using, for example, fixtures and racks. Next, either a cathodic pulse electroforming current, step 240a, is applied to form waveguide features with cooling channels or, alternatively, a cathodic and anodic pulse reverse electroforming current, step 240b, is applied to form completely filled corrugated waveguide features without voids. Additional material may be electrodeposited, step 250, on the surface of the corrugated waveguide using a cathodic direct current. An anodic and cathodic pulse reverse surface finishing current, step 260, can be applied to remove the excess material from the external surface and smooth the surface of the corrugated waveguide. After the electroforming procedure, the mandrel with waveguide coating is removed, step 270, from the electroforming cell. Finally, the mandrel is dissolved, step 280, from the corrugated waveguide.

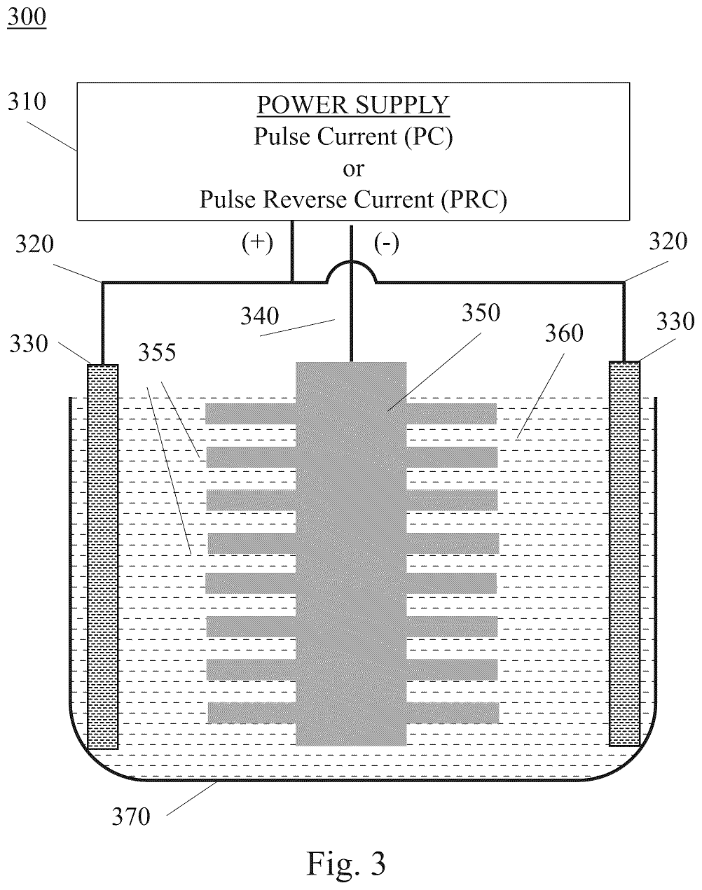

In FIG. 3 is illustrated a corrugated waveguide electroforming system 300. The corrugated waveguide electroforming system 300 comprising a power supply 310 capable of delivering either pulse or pulse reverse electroforming current through cathodic connection 340 (connected to mandrel 350) and anodic connection 330 (connected to anode 330) to an electroforming cell 370. The mandrel 350 with external corrugations 355 is placed in the electroforming cell 370 containing electroforming electrolyte bath 360. Preferably, the electroforming electrolyte bath 360 is devoid of brighteners, accelerators, or levelers to avoid decreasing the resulting copper electrodeposit purity and/or resistivity and/or to prevent outgassing and/or to prevent irregular voids which would affect the performance of the resulting waveguide. The electroforming electrolyte bath 360 may include copper ions, sulfuric acid, chloride, and polyethylene glycol, in one example. Preferably, the mandrel 350 with external corrugations 355 is fabricated from aluminum or aluminum alloys or other material which may be easily and selectively dissolved from the copper waveguide material.

Mandrel 350 with external corrugations 355 is proximate copper anode 330 to replenish the copper ions in the bath.

Power supply 310, controlled to apply either pulse or pulse reverse waveforms to the mandrel 350 with external corrugations 355 and anodes 330 to control electroforming of copper to mandrel 350 with external corrugations 355. By proper application of a pulse reverse electroforming current the corrugated copper waveguide features are completely filled without internal voids or defects. By proper application of a pulse electroforming current the corrugated waveguide features contained well-defined consistent channels which may be of value for cooling the corrugated waveguide. In some cases, excess copper is overplated on the external surface of the corrugated waveguide. The excess overplated copper may be completely or substantially removed by application of anodic/cathodic pulse surface finishing current. When the mandrel is excised (e.g., dissolved), from the electroformed corrugated copper waveguide, the result is the waveguide which can be further finished if necessary. Typically, very little machining is required.

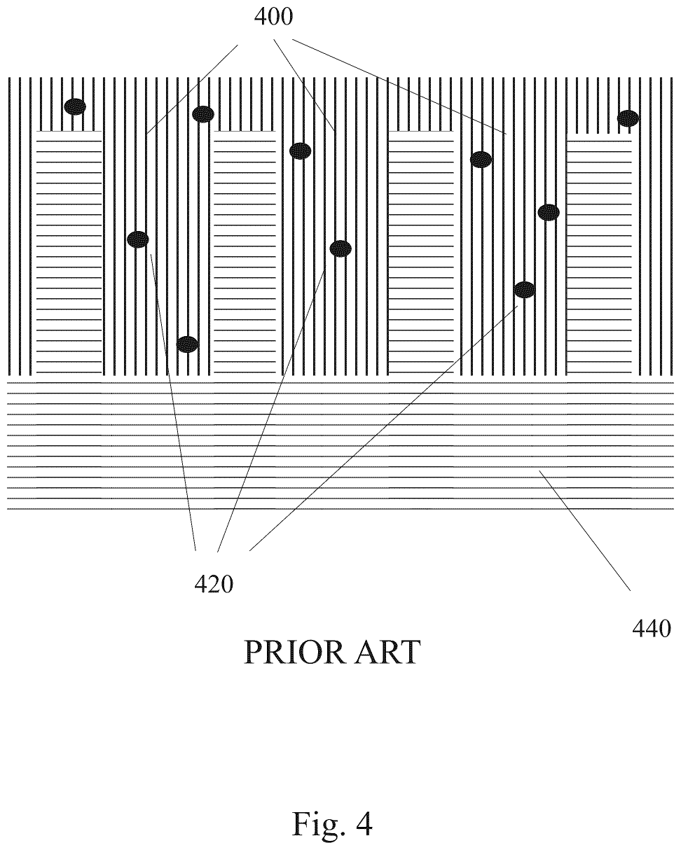

FIG. 4 illustrates a cross-section of direct current electroplating from an electrolyte bath containing conventional additives such as accelerators, brighteners, levelers and the like onto a substrate 440 with features. While the features 400 can be filled, due to the presence of additives such as accelerators, brighteners, levelers and the like, oxygen containing impurities 420 are incorporated in the features. In addition to the difficulties associated with controlling the additive containing electrolyte bath the impurities may adversely impact the conductivity and compromise other properties of the features.

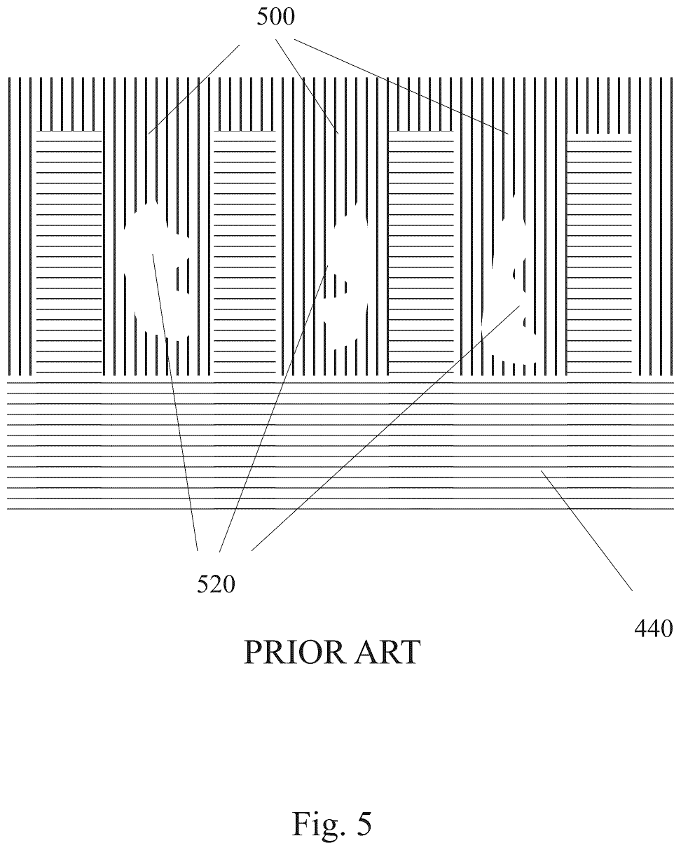

FIG. 5 illustrates a cross-section of direct current electroplating from an electrolyte bath devoid of conventional additives such as accelerators, brighteners, levelers and the like onto a substrate 440 with features. While the features 500 can be partially filled, due to the absence of additives such as accelerators, brighteners, levelers and the like, irregular voids 520 are incorporated in the features. The presence of irregular voids 520 may adversely impact the conductivity and compromise other properties of the features.

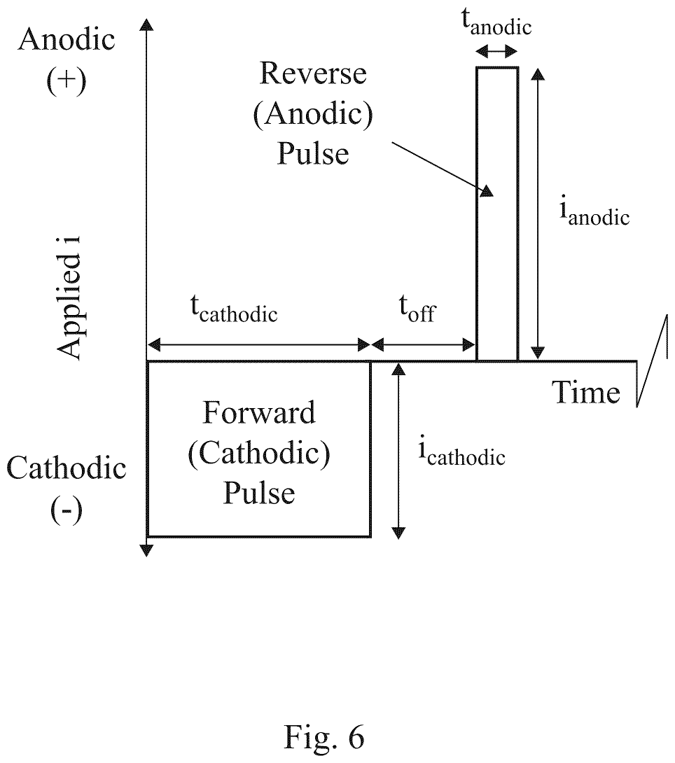

A suitable pulsed waveform (FIG. 6) is an interrupted, asymmetric waveform characterized by a forward pulse followed by a reverse pulse and/or an off time, the positions of which may be interchangeable. For electrodeposition, the forward pulse is cathodic and reverse pulse is anodic. The waveform parameters are: (1) cathodic pulse current density, i_{cathodic}, (2) cathodic on time, t_{cathodic}, (3) anodic pulse current density, i_{anodic}, (4) anodic on time, t_{anodic}, and (5) off-time, t_{off}. The sum of the cathodic and anodic on times and off time is the period, T. The inverse of the period is the frequency, f. The anodic, γa, and cathodic, γc, duty cycles are the ratios of the respective on times to the pulse period. The average current density or net deposition rate is:

iaver=icβc−iaγa (1)

There are various combinations of peak current densities, duty cycles, and frequencies to obtain a given deposition rate, providing the potential for greater process/product control as compared to DC processes. The use of pulse electrodeposition and all of its waveform variations have offered a means of producing unique layers with unique properties. With recent improvements in the output, control and accuracy of power supplies, pulse reverse electrodeposition is possible.

The preferred cathodic current ranges from 10 to 50 mA/cm² with cathodic current on-times that range from 0.1 to 100 ms and the preferred anodic current ranges from 5 to 200 mA/cm² and the anodic current on-times range from 0.1 to 10 ms. The method of claim 27 in which the thickening method includes a cathodic current range of to 100 mA/cm² and cathodic on-time of 10 to 50 ms and an anodic current range of 50 to 100 mA/cm² and anodic on-time of 1 to 5 ms.

Strategies that can be generalized approaches towards inhibiting non-uniform electrodeposits involve pulse/pulse reverse electrodeposition. Pulse electrodeposition is a mature technology, and often used in conjunction with additive-containing electrolytes for a variety of metals. Similar to DC, pulse electrodeposition employs a relatively high (large amplitude) cathodic polarization to drive reduction of cations at the surface. However, in contrast to DC electrodeposition, the duration of the cathodic pulse is limited to ensure the cations concentration does not approach zero near the surface. This is achieved by embedding an off-time after the pulse to allow for cations from the bulk electrolyte to diffuse and replenish the surface concentration. Proper selection of the off-time enables a significantly higher limiting current density to be used. Alternatively, a short anodic pulse follows the cathodic pulse to selectively dissolve asperities or sharp protrusions to replenish the cations at the electrode-electrolyte interface. As a result, electrodeposits at sharp points or edges (localized regions of high current density) would not experience thickness accumulation, ensuring complete and conformal coverage of the workpiece.

One innovation is the ability to produce impurity-free and oxygen-free copper waveguides for operation in higher than conventional frequencies (e.g., 30-300 GHz), by developing electroforming conditions that resulted in void-free copper filling of corrugation valleys on the mandrel, which directly transferred to the waveguide as solid corrugations, using low-additive electrolyte. Specifically, the 26 GHz high-purity copper waveguides exhibited an inner diameter of ˜7 mm, with a corrugation period of 1.38 mm (0.5 mm peak width; 0.88 mm trench width). The corrugations were approximately rectangular (containing rounded peak/trench edges) with peak heights of 2.03-2.28 mm.

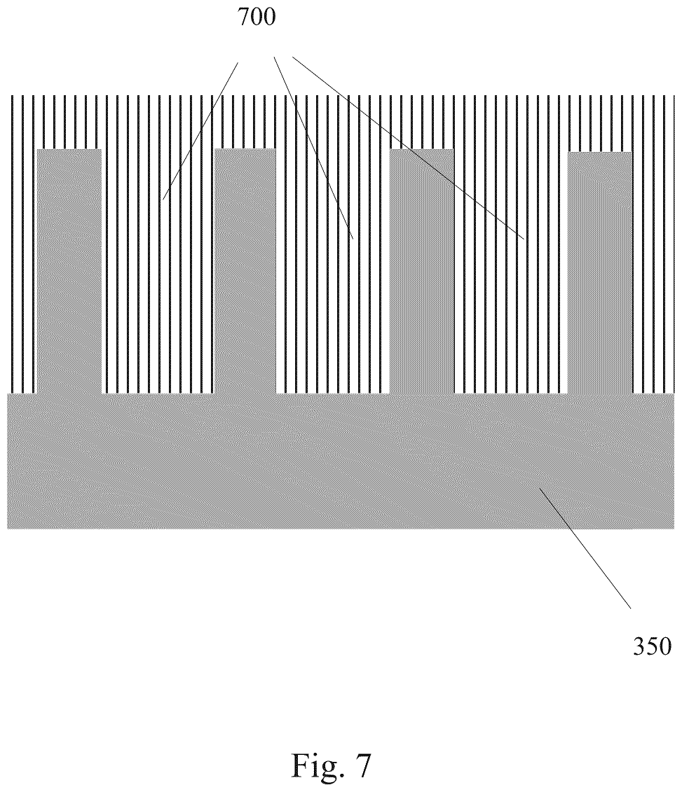

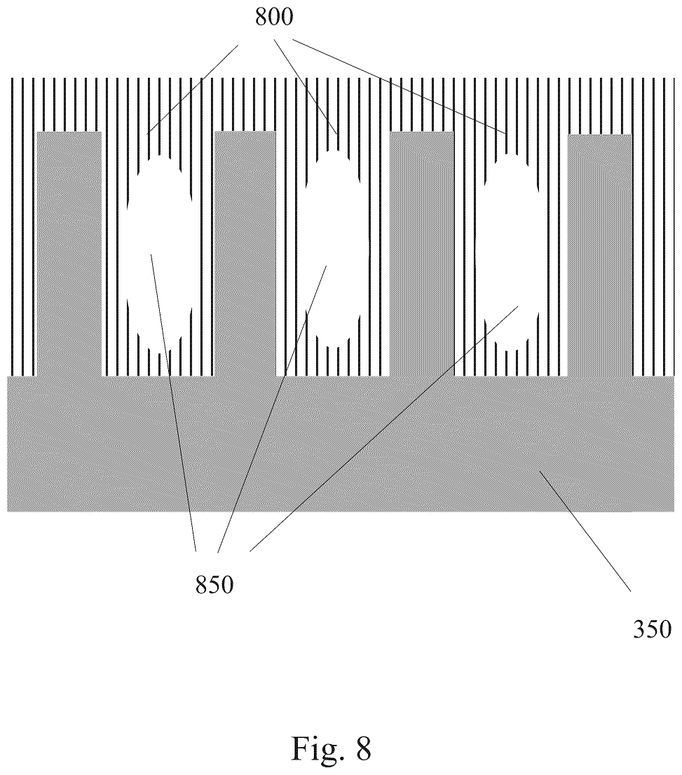

Low-cost materials, such as 2011 series and 6061 series aluminum alloys, can be used to fabricate mandrels that exhibit well-defined corrugation features. The shape and dimensions of corrugation features on the mandrels precisely reflect and complement the target, internal corrugation features of the 26 GHz waveguide. Various pulse waveforms were employed to exert control during the electroforming process in order to achieve targeted results. An example of this is illustrated in FIG. 7 where the application of the appropriate pulse reverse electroforming current waveforms result in waveguides 700 containing completely filled solid corrugations on mandrel 350 with external corrugations 355. Another example of this is illustrated in FIG. 8 where the application of the appropriate pulse electroforming current waveforms result in waveguides 800 containing corrugations with well-defined channels on mandrel 350 with external corrugations 355.

The electroformed copper can be effectively separated from the mandrel using commercially available chemicals. The aluminum alloy mandrel can be chemically dissolved using a hot (50-70° C.) concentrated caustic solution containing sodium hydroxide (NaOH, lye). The hot caustic solution exclusively dissolves the aluminum alloy mandrel, leaving the copper electroform unaffected. The residual elements that form a dark/black smut on the surface of the copper waveguide was easily removed/de-smutted in dilute (1-5 vol %) acid to arrive at the final waveguide configuration.

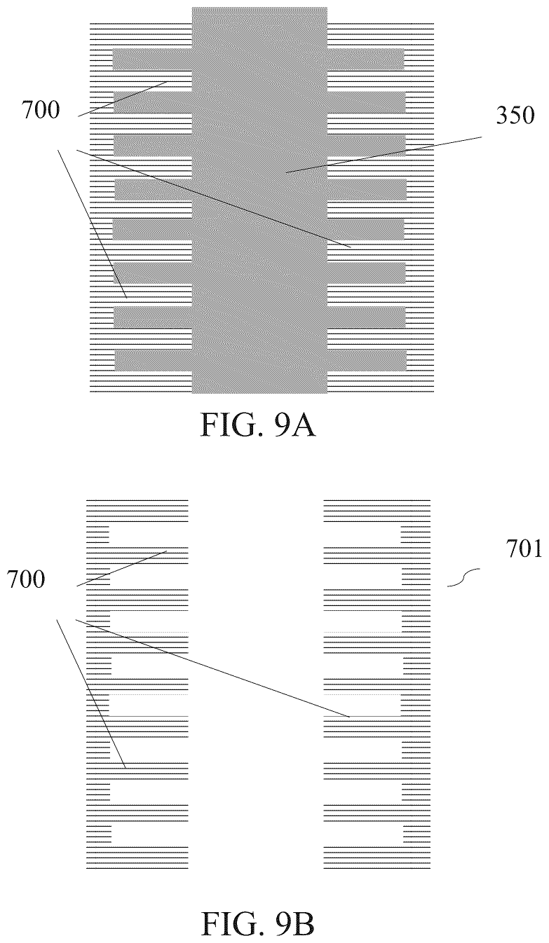

As illustrated in FIG. 9, shape fidelity was transferred from the mandrel to the copper electroform. Prior to mandrel removal (FIG. 9A), the copper electroform is conformally deposited and exhibits complementary waveguide 701 with corrugation peaks 700 which are interdigitated with the corresponding mandrel corrugations. Upon mandrel 350 removal (FIG. 9B), only the copper electroform waveguide 701 remains. It is noteworthy that the copper corrugations remain intact and unaffected by the mandrel removal process. Additionally, the shape fidelity along with dimensional accuracy is further interrogated via non-contact optical profilometry and indicate excellent match to the target geometries was observed.

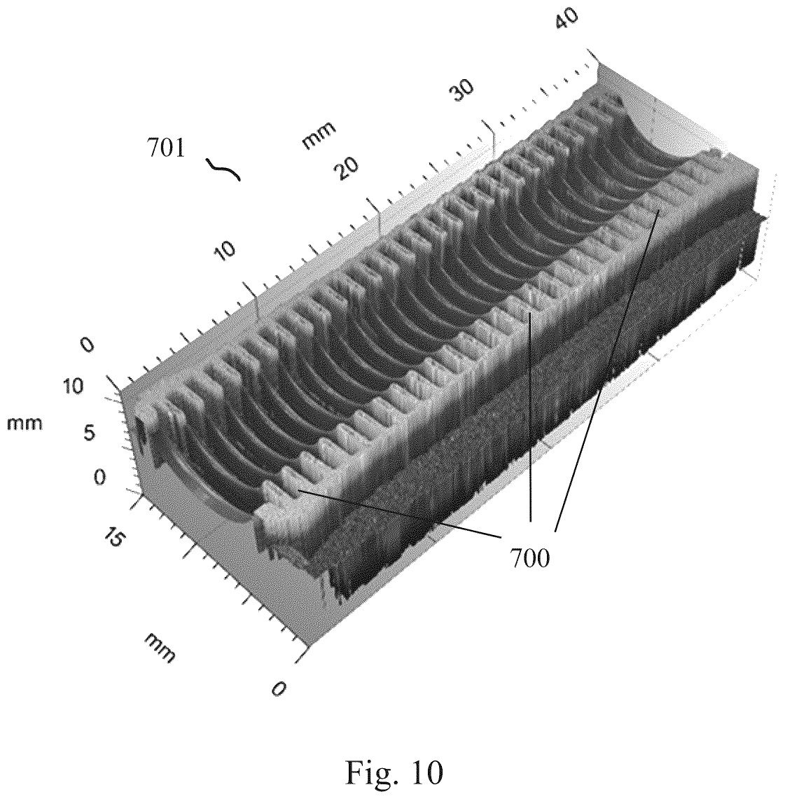

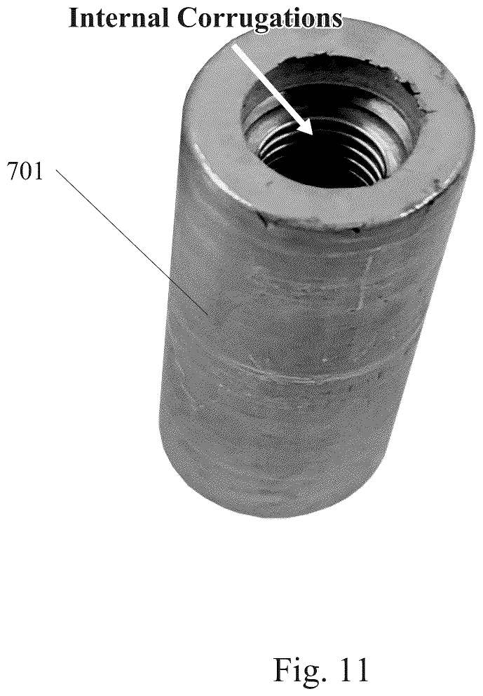

The shape fidelity along with dimensional accuracy is further interrogated via non-contact optical profilometry and indicate excellent match to the target geometries. Copper waveguide 701 is presented in FIG. 10 and demonstrates that pulse-modulated electroforming was successful in fabricating a waveguide 701 with uniform, well-defined, internal corrugations or teeth 700. FIG. 11 shows the copper waveguide 701 after additional copper was electrodeposited onto the surface, and then machined down to give a smooth external cylinder for interfacing with the testing apparatus.

Lastly, residual-resistivity ratio (RRR) measurements evaluate the purity of the copper waveguide. RRR is typically used as a quantitative estimate of the purity in metals, with high RRR values implying higher purity. RRR of a material is expressed as the ratio of resistivity (p) at room temperature (298 K) to the residual resistivity at 4.2 K. A RRR value of approximately 100 is reported for oxygen-free copper (99.96%) by Rosenblum, S., et al. Cryogenics, 17, 645 (1977). The electroforming process of the instant invention based on electroformed copper waveguide from electrolyte devoid of additives yield RRR values of 490 to 860.

In addition to enhanced precision, the electroforming process/apparatus offers substantial savings in terms of operating and intangible costs due to the reduction in chemical additives and their required maintenance and calibration schedules. A preliminary analysis of the economic viability of the electroforming process in terms of the copper and aluminum mandrel materials used would be consistent across the entire electroforming industry. The benefits accrued through the electroformed copper purity and elimination of difficult to control chemical additives provides added cost benefit in terms of elimination of the tangible cost of chemical additives and the intangible cost in terms of electroforming process robustness.

In another embodiment, the corrugated waveguide is fabricated using a pulse reverse current waveform with net cathodic charge to electroform copper onto an aluminum mandrel. Next, additional copper is electrodeposited on the electroformed copper corrugated waveguide using direct current. Finally, excess copper is removed from the copper waveguide while smoothing the surface using a pulse reverse current waveform with net anodic charge.

### WORKING EXAMPLE I

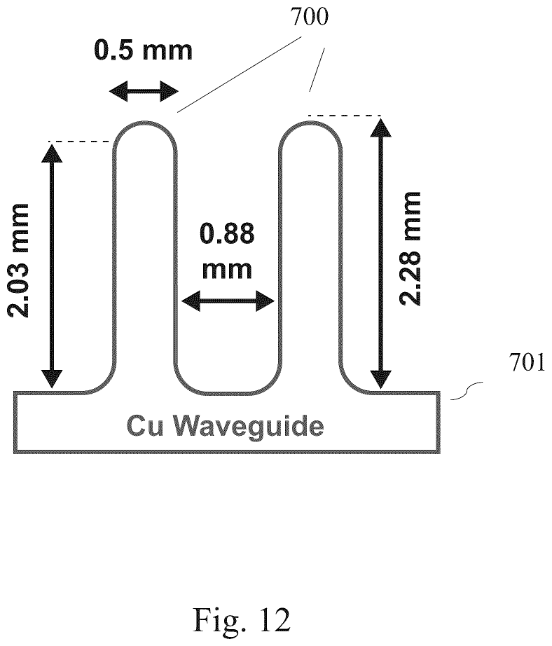

A 26 Ghz waveguide 701 with corrugation 700 dimensions described in FIG. 12 was prepared using the pulse reverse electroforming approach described in the instant invention. The mandrel was fabricated from aluminum with an approximate surface area of 52 cm². The anode consisted of high purity phosphorized copper balls/spheres of approximately 0.5-inch diameter anode as described in Table II. The addition of phosphorus to the copper aids in the dissolution of the copper anode under an electric current. During electroforming, the high purity copper anode dissolves and replenishes the copper in the electroforming bath. The electroforming bath was devoid of commonly used brighteners, accelerators and levelers and consisted of copper sulfate, sulfuric acid, hydrochloric acid, and polyethylene glycol as described in Table III. The copper sulfate provides a source of copper ions for the electroforming process. During the electroforming reaction, the copper ions are replenished by the copper dissolving from the copper anode. The sulfuric acid acts as a supporting electrolyte with good ionic conductivity for the electroforming reaction. The polyethylene glycol and hydrochloric acid additions aid in the recrystallization of the electroformed copper. Note the absence of the difficult to control additives including accelerators, brighteners and levelers. The copper grain size and distribution are controlled by the proper selection of the waveform parameters.

TABLE II
High Purity Phosphorized Anode Composition

| | Chem. Formula | | |
|---|---|---|---|
| Chemical Name | (or abbriv.) | CAS-No. | Composition |
| Copper | Cu | 7440-50-8 | 99.935%-99.96% |
| Phosphorus | P | 7723-14-0 | 0.04%-0.065% |

TABLE III
Electroforming Electrolyte Composition

| | Chem. Formula | | | |
|---|---|---|---|---|
| Chemical Name | (or abbriv.) | CAS-No. | Concentration | |
| Copper Sulfate | CuSO₄•5H₂O | 7758-99-8 | 95-100 | g/L |
| Pentahydrate | | | | |
| Sulfuric acid | H₂SO₄ | 7664-93-9 | 205-210 | g/L |
| Chloride (as HCl) | Cl— (as HCl) | 7647-01-0 | 60-70 | ppm |
| Poly(ethylene glycol), | PEG | 25322-68-3 | 350 | ppm |
| ave. mol. wt.: 3,350 | | | | |

The pulse reverse electroforming waveform parameters consisted of 1.57 A cathodic current for 0.2 ms followed by 0.28 anodic current for 0.4 ms with a pulse period of 0.6 ms and pulse frequency of approximately 1,666 Hz and an average current of 0.337 A. The electroforming was conducted for approximately 48 hours. The cross section of the corrugated waveguide features indicated complete copper filling of the features. The resulting copper electroformed waveguides exhibited RRR values of approximately 751 to 866. Minimal machining of excess electroformed copper from the surface was required.

### WORKING EXAMPLE II

Another 26 GHz waveguide with corrugated dimensions, anode and electrolyte described in WORKING EXAMPLE I was prepared on an aluminum mandrel with the pulse reverse electroforming approach described in the instant invention. The pulse reverse electroforming waveform parameters consisted of 1.5 A cathodic current for 10 ms followed by 3 A anodic current for 2 ms with a pulse period of 12 ms and pulse frequency of approximately 83 Hz and an average current of 0.75 A. The electroforming was conducted for approximately 24 hours. The cross section of the corrugated waveguide features indicated partial copper filling of the features resulting in voids within the corrugated features. These voids could be valuable as a means for providing internal cooling channels for waveguides. The resulting copper electroformed waveguides exhibited RRR values of approximately 491.

### WORKING EXAMPLE III

Another 26 GHz waveguide with corrugated dimensions, anode and electrolyte described in WORKING EXAMPLE I was prepared on an aluminum mandrel with the pulse reverse electroforming approach described in the instant invention. The pulse reverse electroforming waveform parameters consisted of 1.5 A cathodic current for 10 ms followed by 9 A anodic current for 1 ms with a pulse period of 11 ms and pulse frequency of approximately 91 Hz and an average current of 0.545 A. The electroforming was conducted for approximately 24 hours. The cross section of the corrugated waveguide features indicated partial copper filling of the features resulting in voids within the corrugated features. These voids could be valuable as a means for providing internal cooling channels for waveguides.

### WORKING EXAMPLE IV

Another 26 GHz waveguide with corrugated dimensions, anode and electrolyte described in WORKING EXAMPLE I was prepared on an aluminum mandrel with the pulse reverse electroforming approach described in the instant invention. The pulse reverse electroforming waveform parameters consisted of 1.57 A cathodic current for 2 ms followed by 0.28 A anodic current for 4 ms with a pulse period of 6 ms and pulse frequency of approximately 167 Hz and an average current of 0.337 A. The electroforming was conducted for approximately 48 hours. The cross section of the corrugated waveguide features indicated partial copper filling of the features resulting in voids within the corrugated features. These voids could be valuable as a means for providing internal cooling channels for waveguides.

### WORKING EXAMPLE V

In some instances, after the complete or partial filling of the corrugated waveguide features is completed, one skilled in the art understands that it is often desirable to thicken the waveguide with additional plated copper before excising the mandrel. Further, the thickening process should be conducted at as high a plating rate as possible to reduce waveguide processing time and cost. For this and other reasons, the thickening electroforming parameters are not necessarily the same filling electroforming parameters. Waveguide thickening was conducted using the same electroforming electrolyte and high purity copper anode configuration described in WORKING EXAMPLE I.

After complete or partial thickening of the corrugated waveguide features described in WORKING EXAMPLE I, thickening of the waveguide was conducted using direct current (DC) electroplating parameters of 1.12 A for 41.5 hours. The resulting over plated copper exhibited a roughened and irregular surface with poor dimensional control. Post electroforming including corrugated feature filling and thickening with mechanical machining resulted in an external surface with unacceptable roughness and poor dimensional accuracy.

### WORKING EXAMPLE VI

Waveguide thickening was conducted using the same electroforming electrolyte and high purity copper anode configuration described in WORKING EXAMPLE I.

After complete or partial thickening of the corrugated waveguide features described in WORKING EXAMPLE I, thickening of the waveguide was conducted using pulse reverse current electroforming parameters consisted of 1.5 A cathodic current for ms followed by 3 A anodic current for 2 ms with a pulse period of 12 ms and pulse frequency of approximately 83 Hz and an average current of 0.75 A. The electroforming was conducted for approximately 48 hours. The resulting over plated copper exhibited a smooth and regular surface with good dimensional control with the exception of the edge effects. One skilled in the art understands that the edge effects can be eliminated or minimized with appropriate masking to ameliorate the edge effects. Post electroforming including corrugated feature filling and thickening with mechanical machining resulted in an external surface with acceptable roughness and good dimensional accuracy.

Specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A method of manufacturing a corrugated copper microwave waveguide, the method comprising:
placing a mandrel with external corrugations in an electrolyte bath substantially devoid of brighteners, accelerators or levelers and including copper ions, sulfuric acid, chloride, and polyethylene glycol;
locating a copper anode in the bath proximate the mandrel;
applying one or more waveforms to the mandrel and anode to control electrodeposition distribution of copper to the mandrel rather than controlling the electrolyte bath chemistry;
removing the mandrel and the resulting electroformed copper waveguide from the electrolyte bath; and
excising the mandrel resulting in a microwave waveguide with internal corrugations.

2. The method of claim 1 in which the waveguide internal corrugations have a sub-millimeter width.

3. The method of claim 1 in which the waveguide internal corrugations have a sub-millimeter distance between adjacent corrugations.

4. The method of claim 1 in which the copper anode is substantially oxygen free.

5. The method of claim 1 in which the mandrel is made of aluminum or an aluminum alloy.

6. The method of claim 1 in which the waveforms include a cathodic current followed by an anodic current repeated for a predetermined time.

7. The method of claim 6 in which the cathodic current ranges from 10 to 50 mA/cm² with cathodic current on-times that range from 0.1 to 100 ms and the anodic current ranges from 5 to 200 mA/cm² and the anodic current on-times range from 0.1 to 10 ms.

8. The method of claim 6 in which the predetermined time is between 24 and 48 hours.

9. The method of claim 1 further including a waveguide thickening method.

10. The method of claim 9 in which the thickening method includes applying a cathodic current waveform followed by an anodic current waveform for a predetermined time.

11. The method of claim 10 in which the predetermined time is between 24-48 hours.

12. The method of claim 1 in which the waveguide has an inner diameter of approximately 7 mm and a corrugation period of 1.38 mm.

13. The method of claim 1 in which the corrugations are rectangular in cross section.

14. The method of claim 1 in which applying the one or more waveforms to the mandrel and anode to control electrodeposition of copper to the mandrel conformally deposits the copper to the mandrel without dog bone features.

15. The method of claim 1 in which applying the one or more waveforms to the mandrel and anode to control electrodeposition of the copper to the mandrel results in keyholes through the waveguide internal corrugations.

16. The method of claim 1 in which excising the mandrel includes dissolving the mandrel using a hot concentrated caustic solution.

17. The method of claim 1 in which the copper anode has an RRR value of approximately 100 and the copper waveguide has an RRR value of between 490 and 860.

18. A method of manufacturing a corrugated copper microwave waveguide, the method comprising:
placing a mandrel with external corrugations in an electrolyte bath substantially devoid of chemical agents which decrease copper electrode deposit purity and/or resistivity and/or which result in outgassing;
locating a copper anode in the bath proximate the mandrel;
applying repeated cathodic current and anodic current waveforms to the mandrel and anode to electrodeposit a conformal copper electroform to the mandrel;
removing the mandrel and the resulting conformal electroform from the electrolyte bath; and
dissolving the mandrel resulting in a microwave waveguide with internal corrugations.

19. The method of claim 18 in which the waveguide internal corrugations have a sub-millimeter width.

20. The method of claim 18 in which the waveguide internal corrugations have a sub-millimeter distance between adjacent corrugations.

21. The method of claim 18 in which the copper anode is substantially oxygen free.

22. The method of claim 18 in which the mandrel is made of aluminum or an aluminum alloy.

23. The method of claim 18 in which the waveforms include a cathodic current followed by an anodic current repeated for a predetermined time.

24. The method of claim 23 in which the cathodic current ranges from 10 to 50 mA/cm² with cathodic current on-times that range from 0.1 to 100 ms and the anodic current ranges from 5 to 200 mA/cm² and the anodic current on-times range from 0.1 to 10 ms.

25. The method of claim 23 in which the predetermined time is between 24 and 48 hours.

26. The method of claim 18 further including the waveguide thickening method.

27. The method of claim 26 in which the thickening method includes applying a cathodic current waveform followed by an anodic current waveform for a predetermined time resulting in a smooth surface.

28. The method of claim 27 in which the thickening method includes a cathodic current range of 30 to 100 mA/cm² and cathodic on-time of 10 to 50 ms and an anodic current range of 50 to 100 mA/cm² and anodic on-time of 1 to 5 ms.

29. The method of claim 27 in which the predetermined time is between 24-48 hours.

30. The method of claim 18 in which the waveguide has an inner diameter of approximately 7 mm, and a corrugation period of 1.38 mm.

31. The method of claim 18 in which the corrugations are rectangular in cross section.

32. The method of claim 18 in which applying the one or more waveforms to the mandrel and anode to control electrodeposition of copper to the mandrel conformally deposits the copper to the mandrel without dog bone features.

33. The method of claim 18 in which applying the one or more waveforms to the mandrel and anode to control electrodeposition of the copper to the mandrel results in keyholes through the waveguide internal corrugations.

34. The method of claim 18 in which excising the mandrel includes dissolving the mandrel using a hot concentrated caustic solution.

35. The method of claim 18 in which the copper anode has an RRR value of approximately 100 and the copper waveguide has an RRR value of between 490 and 860.

36. The method of claim 18 in which the bath is devoid of brighteners, accelerators, and levelers.

37. The method of claim 36 in which the bath includes copper ions.

38. The method of claim 37 in which the bath includes an ionic conductivity medium and one or more recrystallization mediums.

39. The method of claim 38 in which the bath includes sulfuric acid, chloride, and polyethylene glycol.
